(19) United States
(12) Patent Application Publication
(10) Pub. No.: US 2025/0278859 A1
(43) Pub. Date: Sep. 4, 2025

(54) IMAGE POINT CLOUD DATA PROCESSING DEVICE, IMAGE POINT CLOUD DATA PROCESSING METHOD, AND STORAGE MEDIUM STORING IMAGE POINT CLOUD DATA PROCESSING PROGRAM

(71) Applicant: Mitsubishi Electric Corporation, Tokyo (JP)

(72) Inventors: Toshihito IKENISHI, Tokyo (JP); Daisuke NISHIDA, Tokyo (JP)

(73) Assignee: Mitsubishi Electric Corporation, Tokyo (JP)

(21) Appl. No.: 19/210,465

(22) Filed: May 16, 2025

Related U.S. Application Data
(63) Continuation of application No. PCT/JP2023/002844, filed on Jan. 30, 2023.

(51) Int. Cl. G06T 7/80; G06T 7/73

(52) U.S. Cl. CPC G06T 7/80; G06T 7/73; G06T 2207/10028; G06T 2207/20081

(57) ABSTRACT

An image point cloud data processing device includes processing circuitry to detect a plurality of image feature points in a reference object included in image data generated by a camera and to calculate image representative positions as a plurality of three-dimensional positions representing the reference object based on the plurality of image feature points; to detect an in-region point cloud, as a three-dimensional point cloud existing in a detection region determined based on the image representative positions, in three-dimensional point cloud data generated by a distance measurement sensor and indicating a three-dimensional point cloud, and to detect a representative point cloud representing the reference object based on the in-region point cloud; and to make the image data and the three-dimensional point cloud data be data in a common coordinate system based on the image representative positions and the representative point cloud.

### CROSS-REFERENCE TO RELATED APPLICATION

This application is a continuation application of International Application No. PCT/JP2023/002844 having an international filing date of Jan. 30, 2023, all of which is hereby expressly incorporated by reference into the present application.

### BACKGROUND OF THE INVENTION

### 1. Field of the Invention

The present disclosure relates to an image point cloud data processing device, an image point cloud data processing method and an image point cloud data processing program.

### 2. Description of the Related Art

There has been proposed a combined calibration device for transforming image data obtained by camera photography and three-dimensional point cloud data detected by a distance measurement sensor to data in a common coordinate system (see Patent Reference 1, for example). In this device, a camera and the distance measurement sensor are moved to the front of a calibration board by using a robot arm and registration is executed by using the image data and the three-dimensional point cloud data obtained at that time.

Patent Reference 1 is Japanese Patent Application Publication No. 2022-039906.

However, in the above-described conventional device, it is a precondition that the camera and the distance measurement sensor are moved by the robot arm. Accordingly, there is a problem in that coordinate transformation between the image data and the three-dimensional point cloud data cannot be executed with high accuracy in a real environment in which an object other than the calibration board exists in a photographing range of the camera and a detection range of the distance measurement sensor.

### SUMMARY OF THE INVENTION

An object of the present disclosure is to make the image data and the three-dimensional point cloud data be data in a common coordinate system with high accuracy.

An image point cloud data processing device in the present disclosure includes processing circuitry to detect a plurality of image feature points in a reference object included in image data generated by a camera and to calculate image representative positions as a plurality of three-dimensional positions representing the reference object based on the plurality of image feature points; to detect an in-region point cloud, as a three-dimensional point cloud existing in a detection region determined based on the image representative positions, in three-dimensional point cloud data generated by a distance measurement sensor and indicating a three-dimensional point cloud, and to detect a representative point cloud representing the reference object based on the in-region point cloud; and to make the image data and the three-dimensional point cloud data be data in a common coordinate system based on the image representative positions and the representative point cloud.

An image point cloud data processing method in the present disclosure is a method to be executed by an image point cloud data processing device. The method includes detecting a plurality of image feature points in a reference object included in image data generated by a camera and calculating image representative positions as a plurality of three-dimensional positions representing the reference object based on the plurality of image feature points, detecting an in-region point cloud, as a three-dimensional point cloud existing in a detection region determined based on the image representative positions, in three-dimensional point cloud data generated by a distance measurement sensor and indicating a three-dimensional point cloud, and detecting a representative point cloud representing the reference object based on the in-region point cloud, and making the image data and the three-dimensional point cloud data be data in a common coordinate system based on the image representative positions and the representative point cloud.

With the device, method and program in the present disclosure, the image data and the three-dimensional point cloud data can be made to be data in a common coordinate system with high accuracy.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a functional block diagram schematically showing the configuration of an image point cloud data processing device according to a first embodiment;

FIG. 2 is a diagram showing an example of the hardware configuration of the image point cloud data processing device according to the first embodiment;

FIG. 3 is a flowchart showing the operation of the image point cloud data processing device according to the first embodiment;

FIGS. 4A to 4C are explanatory diagrams showing the operation of an image data processing unit in the first embodiment;

FIGS. 5A to 5D are explanatory diagrams showing the operation of a point cloud data processing unit in the first embodiment;

FIGS. 6A and 6B are explanatory diagrams showing the operation of a registration processing unit in the first embodiment;

FIG. 7 is a flowchart showing the operation of an image point cloud data processing device according to a second embodiment;

FIGS. 8A to 8C are explanatory diagrams showing the operation of the image data processing unit in the second embodiment;

FIGS. 9A to 9D are explanatory diagrams showing the operation of the point cloud data processing unit in the second embodiment;

FIG. 10 is a diagram showing an example of the hardware configuration of an image point cloud data processing device according to a third embodiment;

FIG. 11 is a flowchart showing the operation of the image point cloud data processing device according to the third embodiment;

FIGS. 12A to 12C are explanatory diagrams showing the operation of the image data processing unit in the third embodiment; and

FIGS. 13A to 13C are explanatory diagrams showing the operation of the point cloud data processing unit in the third embodiment.

### DETAILED DESCRIPTION OF THE INVENTION

An image point cloud data processing device, an image point cloud data processing method and an image point cloud data processing program according to each embodiment will be described below with reference to the drawings. The following embodiments are just examples and it is possible to appropriately combine embodiments and appropriately modify each embodiment.

### <1> First Embodiment

### <1-1> Configuration

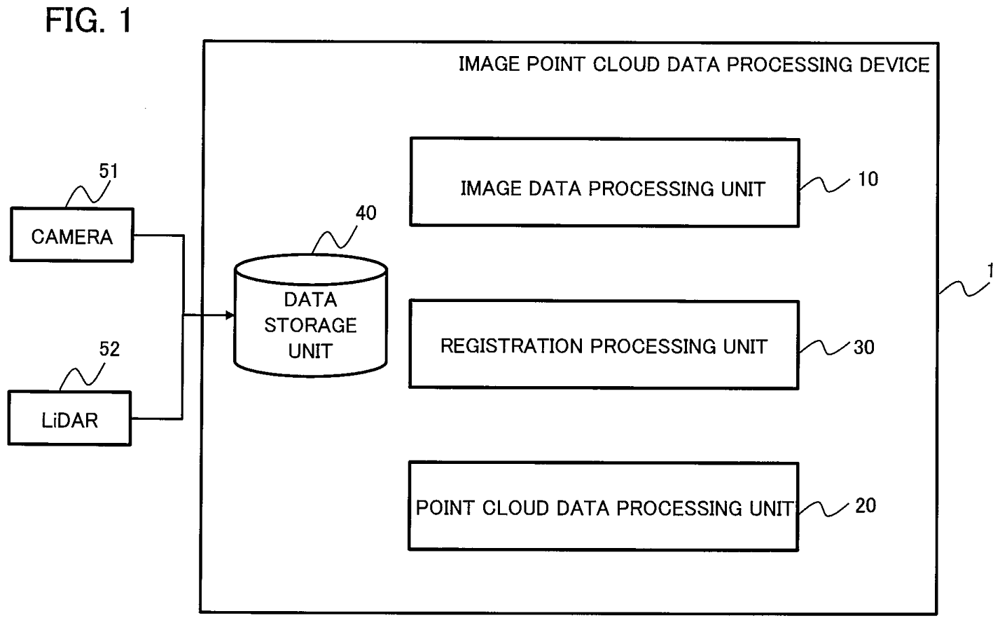

FIG. 1 is a functional block diagram schematically showing the configuration of an image point cloud data processing device 1 according to a first embodiment. The image point cloud data processing device 1 is a device capable of executing an image point cloud data processing method according to the first embodiment, such as a computer capable of executing an image point cloud data processing program according to the first embodiment, for example. The image point cloud data processing device 1 is a device capable of deriving a transformation formula (i.e., transformation matrix of the transformation formula) for making image data obtained by photographing by a camera 51 as an image capturing device and three-dimensional point cloud data detected by a LiDAR (Light Detection And Ranging) 52 as a distance measurement sensor be data in a common coordinate system.

As shown in FIG. 1, the image point cloud data processing device 1 includes an image data processing unit 10, a point cloud data processing unit 20 and a registration processing unit 30. The image point cloud data processing device 1 may further include one or more out of a data storage unit 40 as a storage device that stores the image data and the three-dimensional point cloud data, a communication unit that executes communication with external devices, and a display device that displays images.

The image point cloud data processing device 1 determines the transformation matrix included in the transformation formula for making the image data obtained by the camera 51 in a real environment and the three-dimensional point cloud data detected by the LiDAR 52 in the real environment be data in a common coordinate system. In the real space, it is permissible even if there exists an object (i.e., different object) other than a calibration board as a reference object used for camera calibration. While the camera 51 and the LiDAR 52 are shown in FIG. 1 as devices different from the image point cloud data processing device 1, the camera 51 and the LiDAR 52 can also be parts of the image point cloud data processing device 1.

The image data processing unit 10 detects a plurality of image feature points (e.g., intersection points in a checker pattern) in a calibration pattern of the calibration board included in the image data generated by the camera 51 and calculates image representative positions as a plurality of three-dimensional positions representing the calibration board based on the plurality of image feature points. The plurality of image representative positions are positions of corners of the calibration board, for example.

The point cloud data processing unit 20 detects an in-region point cloud, as a three-dimensional point cloud existing in a detection region determined based on the image representative positions (e.g., the positions of the corners of the calibration board), in the three-dimensional point cloud data generated by the LIDAR 52 and indicating a three-dimensional point cloud, and detects a representative point cloud representing the calibration board as the reference object based on the in-region point cloud. The calibration board has a predetermined calibration pattern. The calibration pattern is a checker pattern in which a plurality of white regions and black regions each in a rectangular shape are alternately arranged two-dimensionally. The calibration pattern can also be a grid pattern formed by a plurality of straight lines arranged like a grid, a dot pattern formed by a plurality of dots arranged two-dimensionally, or the like.

The registration processing unit 30 is a feature point matching processing unit that derives the transformation matrix of the transformation formula, to be used for transformation of the image data and the three-dimensional point cloud data, by means of matching based on the image representative positions calculated by the image data processing unit 10 and the representative point cloud detected by the point cloud data processing unit 20. The registration processing unit 30 calculates the transformation matrix regarding feature points (e.g., points at four corners of the calibration board) extracted from a plurality of images and feature points (e.g., points at the four corners of the calibration board) in the three-dimensional point cloud measured by the LiDAR 52 by using an NDT (Normal Distribution Transform) method or an ICP (Iterative Closest Point) method.

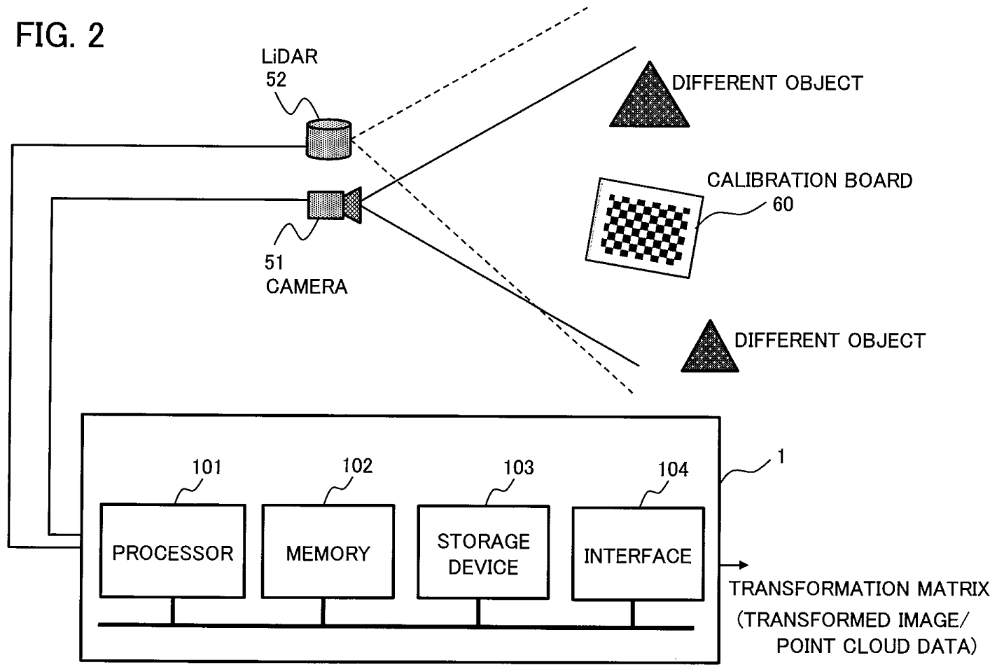

FIG. 2 is a diagram showing an example of the hardware configuration of the image point cloud data processing device 1 according to the first embodiment. The image point cloud data processing device 1 includes, for example, a processor 101 such as a CPU (Central Processing Unit), a memory 102 as a storage unit, a storage device 103, and an interface 104. Parts forming the image point cloud data processing device 1 are formed with processing circuitry, for example. The processing circuitry can either be dedicated hardware or include a CPU that executes a program (e.g., image point cloud data processing program) stored in the memory 102. The processor 101 implements functional blocks shown in FIG. 1.

The memory 102 is, for example, a semiconductor memory such as a RAM (Random Access Memory). The storage device 103 is a nonvolatile storage device such as an HDD (Hard Disk Drive) or an SSD (Solid State Drive). Further, the image point cloud data processing device 1 can include both of a component made with a circuit and a component made with a processor. Furthermore, part or the whole of the image point cloud data processing device 1 can be a server computer on a network. Incidentally, the image point cloud data processing program is provided by means of downloading via a network or through a storage medium (i.e., record medium) storing information such as a USB memory. The storage medium is a non-transitory computer-readable storage medium storing a program such as the image point cloud data processing program. The camera 51, the LiDAR 52, an input device through which user operations are performed, the display device that presents information such as a liquid crystal display, and so forth are connected to the interface 104.

As shown in FIG. 2, while the calibration board 60 as the reference object exists in a photographing range of the camera 51 and a measurement range of the LiDAR 52, different objects other than the calibration board 60 may also exist in the photographing range of the camera 51 and the measurement range of the LiDAR 52. Namely, the image point cloud data processing device 1 is capable of making the image data and the three-dimensional point cloud data be data in a common coordinate system with high accuracy by photographing and measuring the real space in which a lot of objects exist. Further, the image point cloud data processing device 1 is capable of making the display device display an image in which a point cloud based on the three-dimensional point cloud data generated by the LiDAR 52 is superimposed on an image based on image data in the same coordinate system. Furthermore, the image point cloud data processing device 1 is capable of making the display device display an image in which colors based on the image data are added to a surface formed by the point cloud based on the three-dimensional point cloud data generated by the LiDAR 52.

### <1-2> Operation

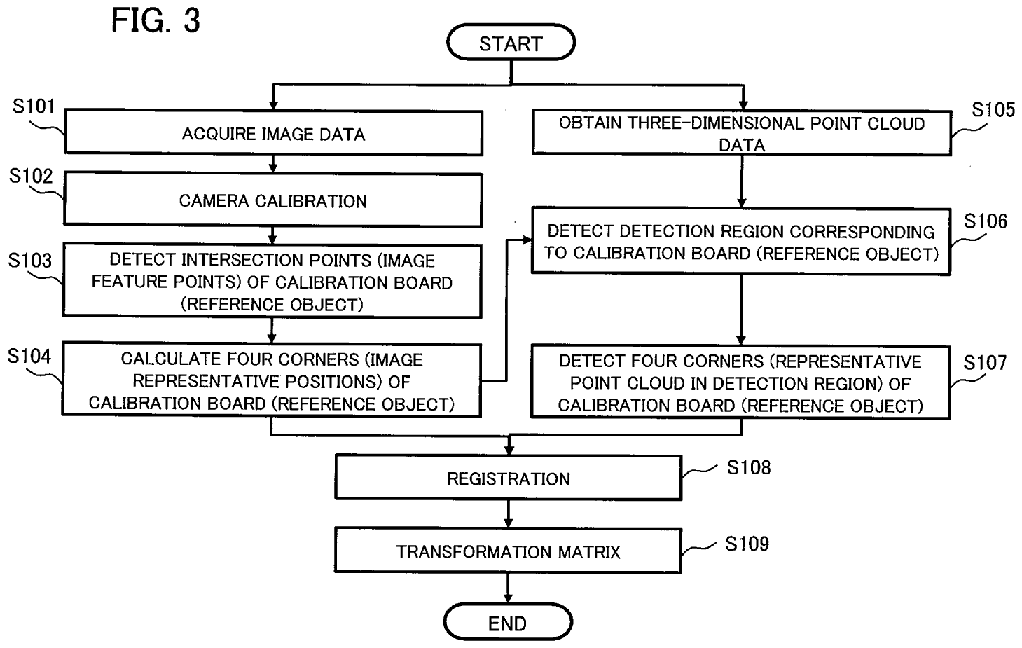

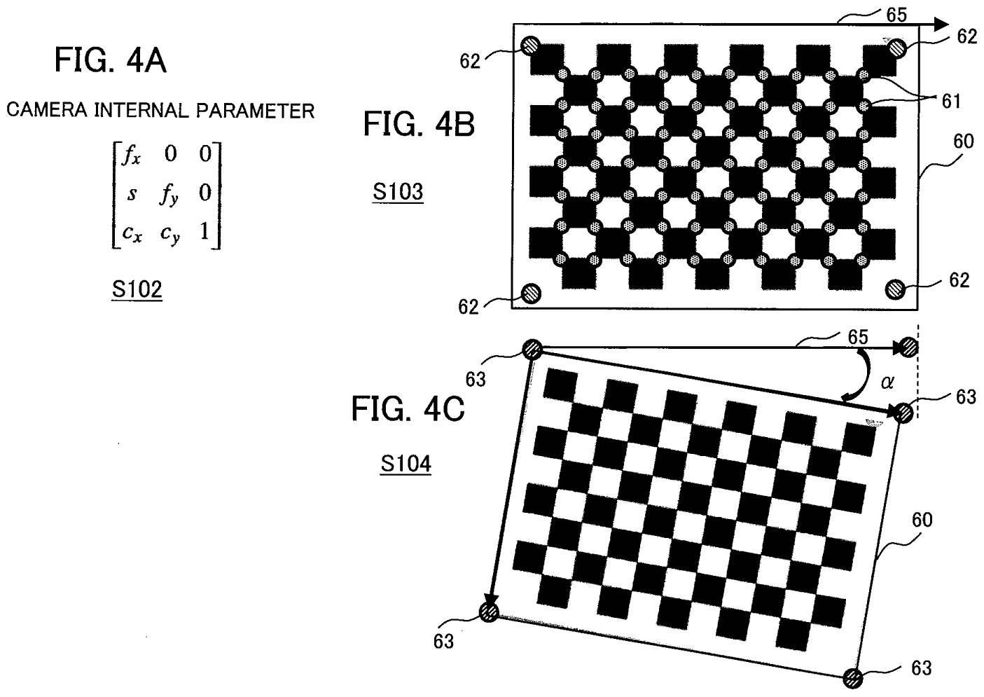

FIG. 3 is a flowchart showing the operation of the image point cloud data processing device 1 according to the first embodiment. FIGS. 4A to 4C are explanatory diagrams showing the operation of the image data processing unit 10.

First, the image data processing unit 10 acquires the image data generated by the camera 51 (step S101) and determines a camera internal parameter by executing the camera calibration by detecting the calibration board 60 as the reference object included in the image data (step S102). FIG. 4A shows a transformation matrix as the camera internal parameter generated by the image data processing unit 10. In FIG. 4A, (cₓ, c_{y}) represents coordinates of a principal point (normally, the image center), and fₓ and f_{y} represent focal distances expressed in units of pixels.

Subsequently, the image data processing unit 10 detects a plurality of image feature points 61 in the calibration pattern of the calibration board 60 (step S103) and calculates image representative positions 63 as a plurality of three-dimensional positions representing the calibration board 60 based on the plurality of image feature points 61 (step S104). FIG. 4B shows the plurality of image feature points 61. FIG. 4C shows the image representative positions 63 as the positions of the four corners of the calibration board 60 obtained based on the plurality of image feature points 61. At that time, the image data processing unit 10 calculates a rotation angle α of the calibration board 60 with respect to a reference direction 65. Incidentally, it is also possible to use positions 62 of corners of the checker pattern being the calibration pattern of the calibration board 60 instead of the image representative positions 63.

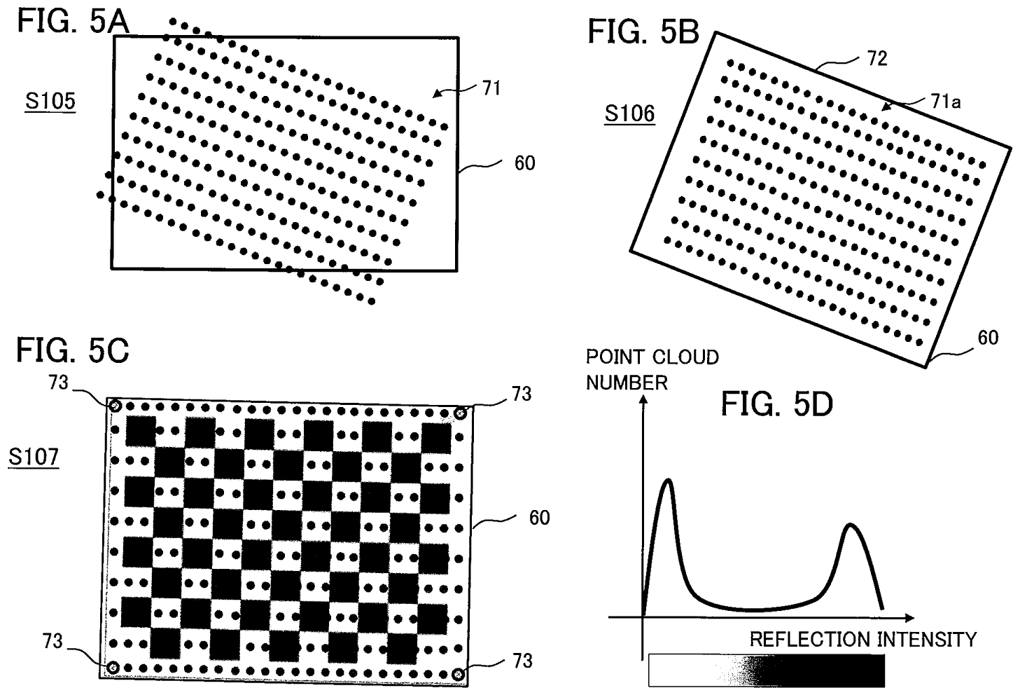

FIGS. 5A to 5D are explanatory diagrams showing the operation of the point cloud data processing unit 20. The point cloud data processing unit 20 acquires a three-dimensional point cloud 71 as a cluster generated by the LiDAR 52 and divided by a method like clustering (step S105) and detects an in-region point cloud 71a as a three-dimensional point cloud existing in a detection region 72 determined based on the image representative positions 63 acquired from the image data processing unit 10 (step S106). FIG. 5A shows the three-dimensional point cloud 71 generated by the LiDAR 52. FIG. 5B shows the in-region point cloud 71a as the three-dimensional point cloud existing in the detection region 72. Each point in the three-dimensional point cloud 71 is a measurement point irradiated with a laser beam.

Subsequently, the point cloud data processing unit 20 detects a representative point cloud 73 representing the calibration board 60 based on the in-region point cloud 71a (step S107). The representative point cloud is a point cloud made up of points representing positions of corners of the calibration board 60. FIG. 5C shows the representative point cloud 73 calculated based on the in-region point cloud 71a as the three-dimensional point cloud existing in the detection region 72. Further, FIG. 5D shows a distribution characteristic of a point cloud number with respect to reflection intensity that is used when detecting the calibration board 60. Namely, the point cloud data processing unit 20 is capable of determining an object having distribution of the point cloud number similar to FIG. 5D (distribution having two peaks) as the calibration board 60.

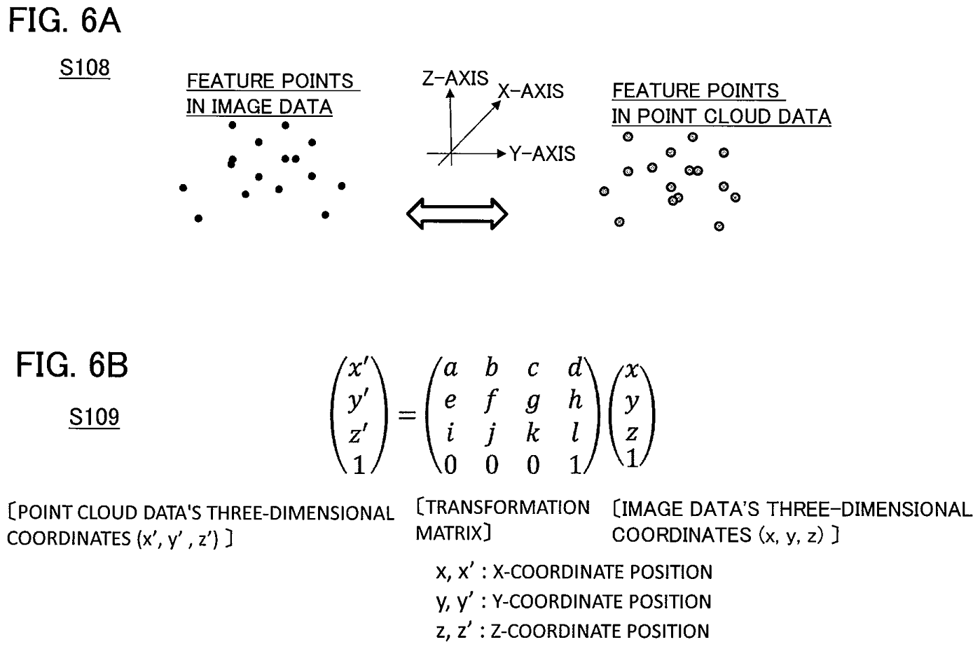

FIGS. 6A and 6B are explanatory diagrams showing the operation of the registration processing unit 30. The registration processing unit 30 executes the matching between the image representative positions 63 calculated by the image data processing unit 10 and represented by three-dimensional data and the representative point cloud 73 calculated by the point cloud data processing unit 20 and represented by three-dimensional point cloud data, namely, executes registration (step S108), and calculates the transformation matrix of the transformation formula for making the image data and the three-dimensional point cloud data be data in a common coordinate system by using the result of the matching (step S109). FIG. 6A shows the registration and FIG. 6B shows a transformation formula of three-dimensional affine transformation between the image data and the three-dimensional point cloud data. Rotation around each axis, magnification/reduction, and parallel movement (translation) can be set by determining the elements a, b, . . . , k and l. However, the transformation formula is not limited to three-dimensional affine transformation.

### <1-3> Effect

As described above, in the first embodiment, the rotation angle α of the calibration board 60 is estimated based on the image data generated by the camera 51, the detection region of the three-dimensional point cloud data generated by the LiDAR 52 is rotated by using the rotation angle α and the three-dimensional point cloud in the detection region is extracted, and the registration between the image representative positions 63 and the representative point cloud 73 is executed, and thus a transformation matrix with high accuracy can be calculated.

Further, by determining an object having the characteristic (two peaks) shown in FIG. 5D as the calibration board 60, a transformation matrix with high accuracy can be derived by using the image data and the three-dimensional point cloud data in a real space in which there exists an object other than the calibration board 60.

### <2> Second Embodiment

### <2-1> Configuration

While an example in which the image representative positions 63 are coordinate points at corners of the calibration board 60 has been described in the first embodiment, an example in which the image representative positions are coordinate points on edges (sides) of the calibration board 60 will be described in a second embodiment. Other features in the second embodiment are in common with the first embodiment, and thus FIG. 1 and FIG. 2 are referred to in the description of the second embodiment.

### <2-2> Operation

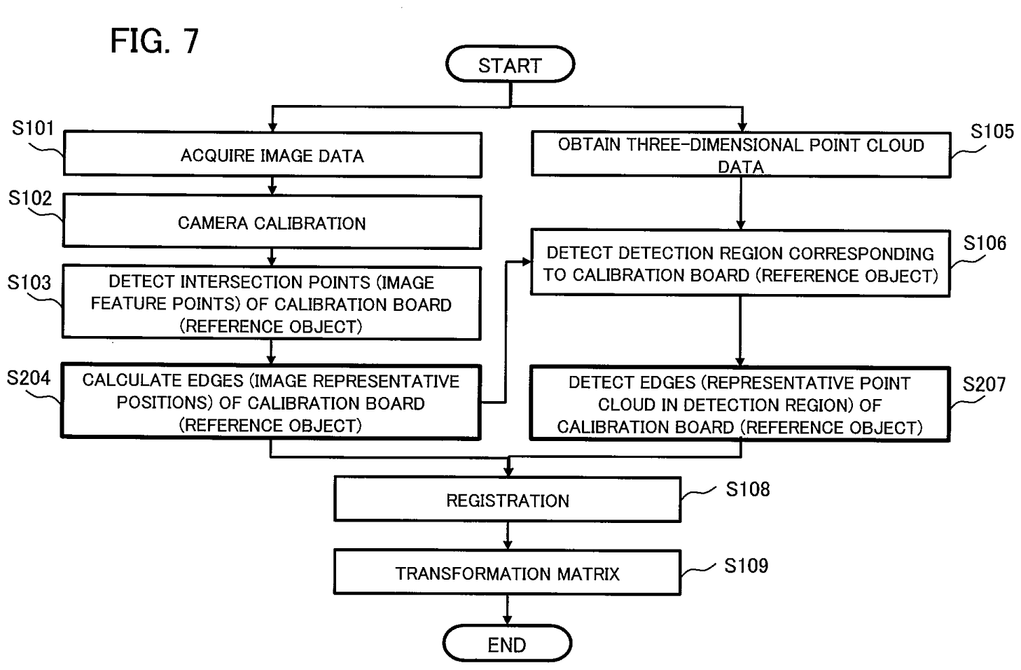

FIG. 7 is a flowchart showing the operation of an image point cloud data processing device according to the second embodiment. In the image point cloud data processing device according to the second embodiment, processing in steps S204 and S207 differs from the processing in the image point cloud data processing device 1 according to the first embodiment.

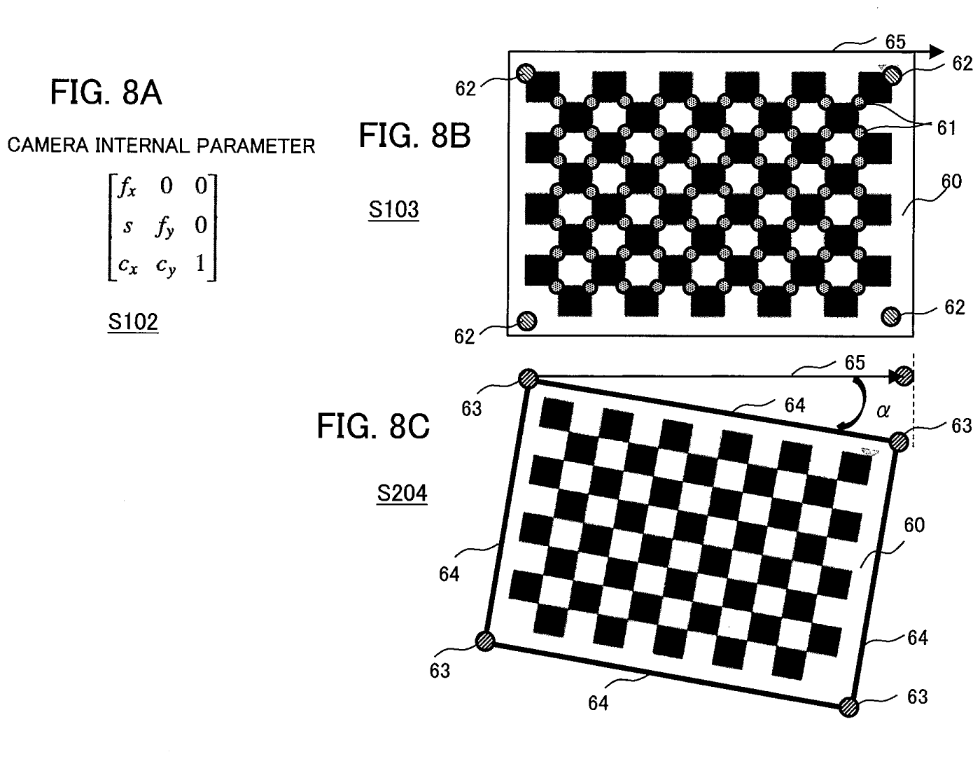

FIGS. 8A to 8C are explanatory diagrams showing the operation of the image data processing unit 10 in the second embodiment. First, the image data processing unit 10 acquires the image data generated by the camera 51 (step S101) and determines the camera internal parameter by executing the camera calibration by detecting the calibration board 60 as the reference object included in the image data (step S102). Similarly to FIG. 4A, FIG. 8A shows the transformation matrix as the camera internal parameter generated by the image data processing unit 10.

Subsequently, the image data processing unit 10 detects a plurality of image feature points 61 in the calibration pattern of the calibration board 60 (step S103) and calculates edges (sides) 64 as a plurality of three-dimensional positions representing the calibration board 60 based on the plurality of image feature points 61 (step S204). FIG. 8B shows the plurality of image feature points 61, and FIG. 8C shows the image representative positions as the positions of the edges 64 of the calibration board 60 obtained based on the plurality of image feature points 61. At that time, the image data processing unit 10 calculates the rotation angle α of the calibration board 60 with respect to the reference direction. Incidentally, it is also possible to use positions of edges of the checker pattern being the calibration pattern of the calibration board 60 instead of the image representative positions 63.

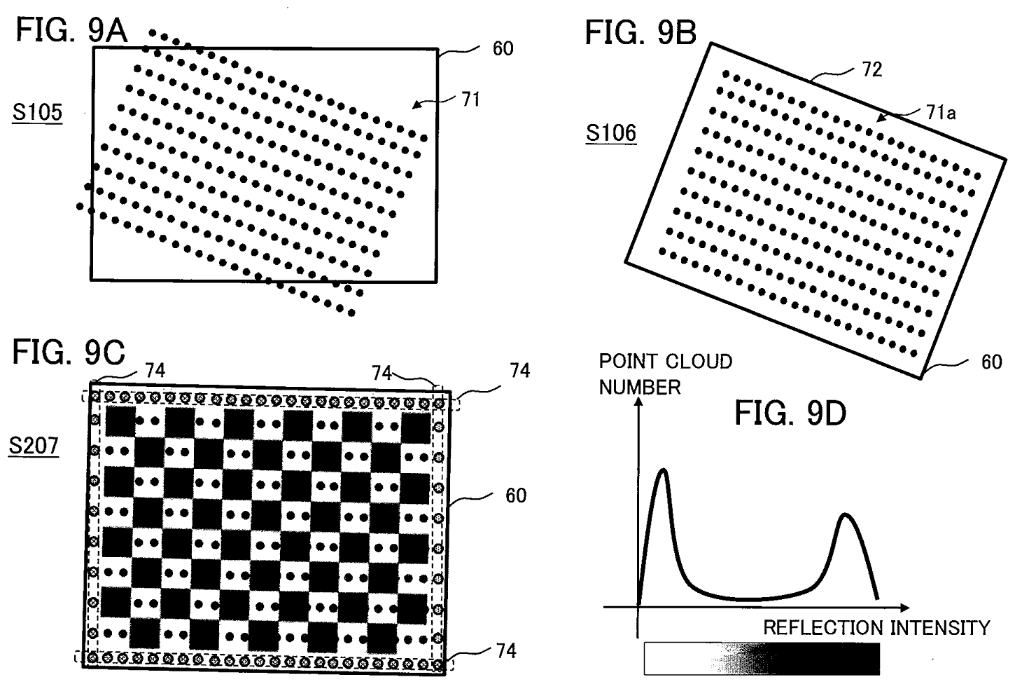

FIGS. 9A to 9D are explanatory diagrams showing the operation of the point cloud data processing unit 20 in the second embodiment. The point cloud data processing unit 20 obtains the three-dimensional point cloud 71 as a cluster generated by the LiDAR 52 and divided by a method like clustering (step S105) and detects the in-region point cloud 71a as the three-dimensional point cloud existing in the detection region 72 determined based on the image representative positions 63 acquired from the image data processing unit 10 (step S106). FIG. 9A shows the three-dimensional point cloud 71 generated by the LiDAR 52. FIG. 9B shows the in-region point cloud 71a as the three-dimensional point cloud existing in the detection region 72.

Subsequently, the point cloud data processing unit 20 detects a representative point cloud 74 of edges representing the calibration board 60 based on the in-region point cloud 71a (step S207). The representative point cloud 74 is a point cloud representing positions of edges of the calibration board 60. FIG. 9C shows the representative point cloud 74 of edges calculated based on the in-region point cloud 71a as the three-dimensional point cloud existing in the detection region 72. Further, FIG. 9D shows the distribution characteristic of the point cloud number with respect to the reflection intensity that is used when detecting the calibration board 60.

The operation of the registration processing unit 30 is the same as that in the first embodiment.

### <2-3> Effect

In the second embodiment, effects similar to those described in the first embodiment can be obtained.

### <3> Third Embodiment

### <3-1> Configuration

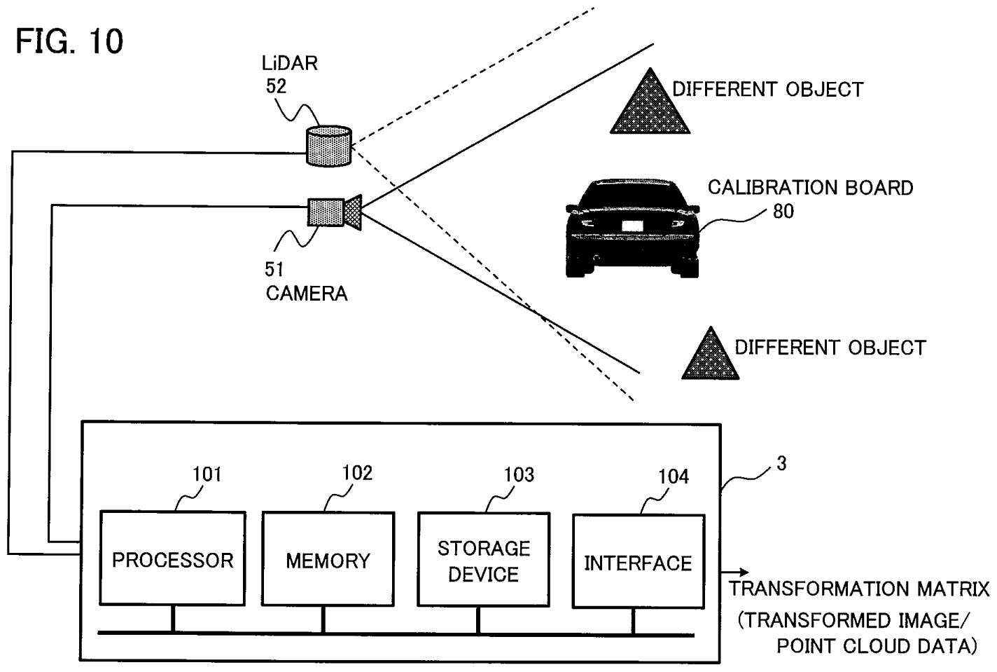

FIG. 10 is a diagram showing an example of the hardware configuration of an image point cloud data processing device 3 according to a third embodiment. In FIG. 10, each component identical or corresponding to a component shown in FIG. 2 is assigned the same reference character as in FIG. 2. While examples in which the reference object is the calibration board 60 having the calibration pattern have been described in the first and second embodiments, the reference object is a detection object (e.g., vehicle) 80 in the third embodiment. The detection object 80 does not need to have the calibration pattern as a predetermined pattern. Further, FIG. 1 as the functional block diagram is referred to in the description of the third embodiment.

### <3-2> Operation

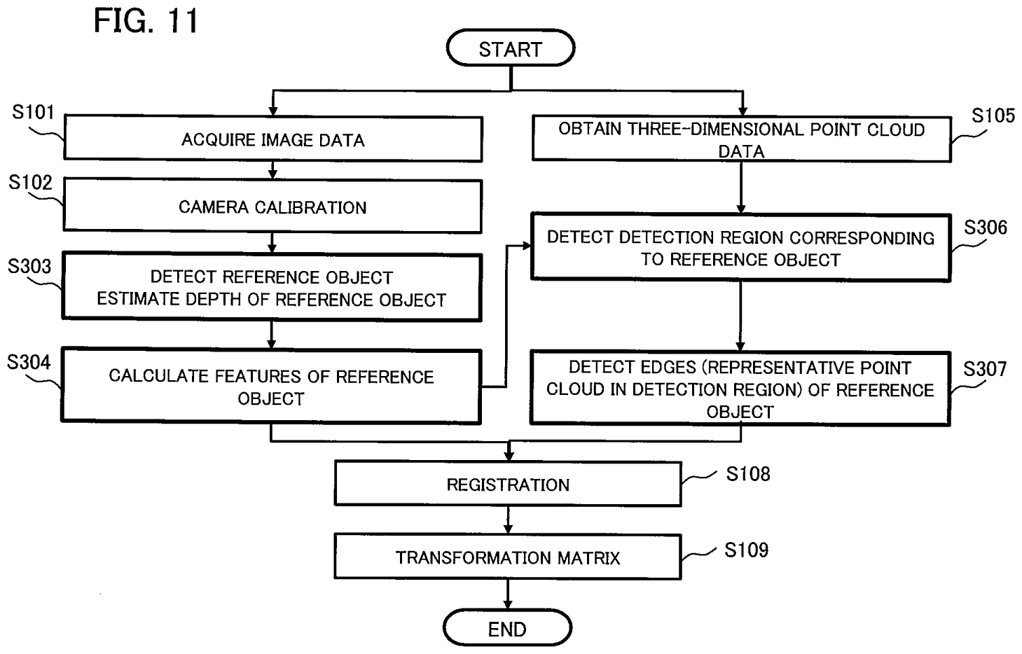

FIG. 11 is a flowchart showing the operation of an image point cloud data processing device 3 according to the third embodiment. In the image point cloud data processing device 3 according to the third embodiment, processing in steps S303, S304, S306 and S307 differs from the processing in the image point cloud data processing device 1 according to the first embodiment.

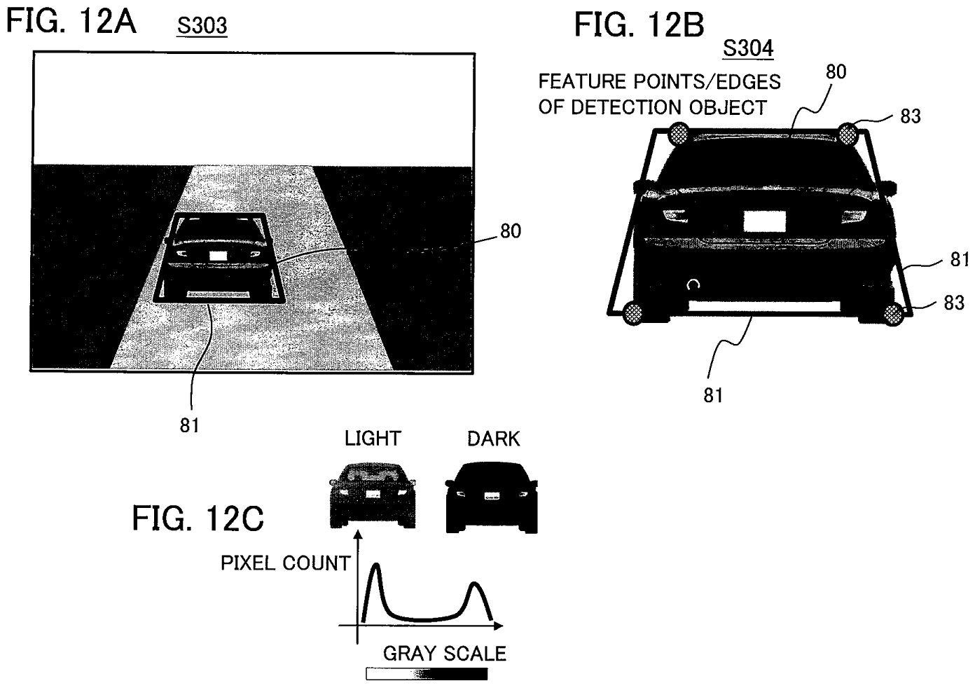

FIGS. 12A to 12C are explanatory diagrams showing the operation of the image data processing unit 10 in the third embodiment. First, the image data processing unit 10 acquires the image data generated by the camera 51 (step S101) and determines the camera internal parameter by executing the camera calibration by detecting the detection object 80 (vehicle in the diagrams) as the reference object included in the image data (step S102).

Subsequently, the image data processing unit 10 detects the detection object 80 in the image data by using color distribution of the image data as a feature value and estimates depth of the detection object 80 (step S303). In this case, it is also possible to detect the object in the image data obtained by camera photography by means of deep learning, estimate the depth, and obtain feature points.

Subsequently, the image data processing unit 10 extracts edges, four corner points and color distribution of the detection object 80 as feature values and transforms the image data from two-dimensional image data to three-dimensional image data (step S304). FIGS. 12A and 12B shows a process of calculating the detection object 80, a plurality of image representative positions 83, and edges (sides) 81 of the detection object. FIG. 12C indicates that the detection object has light and shade and thus distribution of a pixel count of the detection object with respect to the gray scale (gradation) has a particular tendency (e.g., having a peak of the pixel count at a high gray level and a peak of the pixel count at a low gray level).

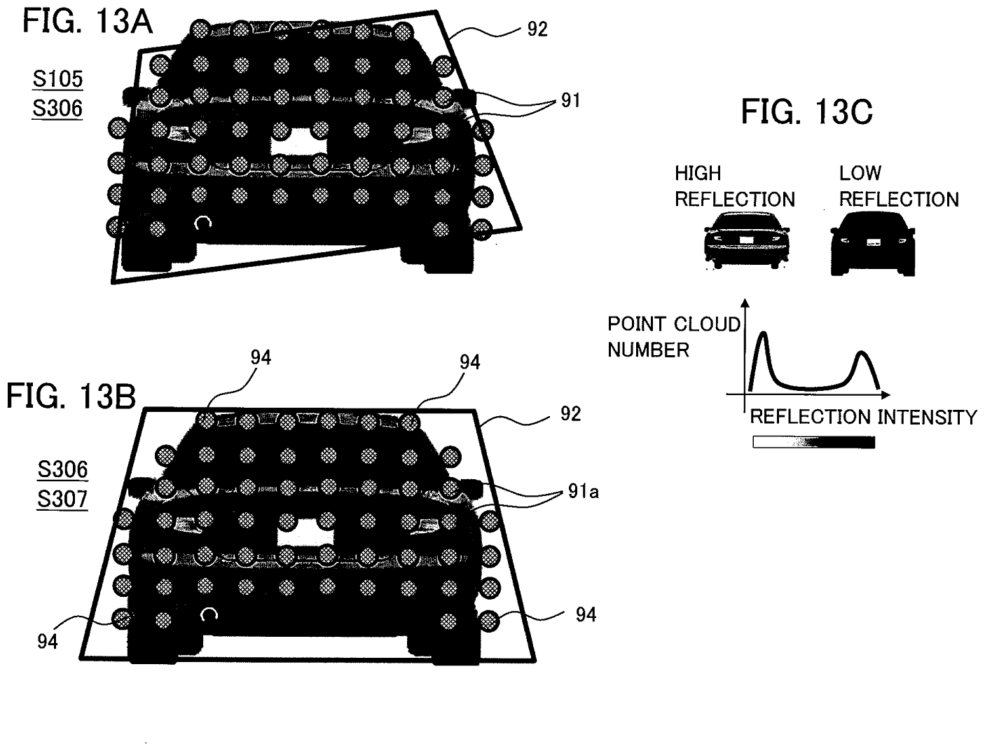

FIGS. 13A to 13C are explanatory diagrams showing the operation of the point cloud data processing unit 20 in the third embodiment. The point cloud data processing unit 20 obtains a three-dimensional point cloud 91 as a cluster generated by laser scanning by the LiDAR 52 and divided by a method like clustering (step S105) and detects an in-region point cloud 91a as a three-dimensional point cloud existing in a detection region 92 determined based on the image representative positions 83 or the edges 81 acquired from the image data processing unit 10 (step S306). FIG. 13A shows the three-dimensional point cloud 91 generated by the LiDAR 52. FIG. 13B shows the in-region point cloud 91a as the three-dimensional point cloud existing in the detection region 92. FIG. 13C indicates that the detection object has light and shade and thus the distribution of the pixel count of the detection object with respect to the gray scale (light and shade) has a particular tendency.

Subsequently, the point cloud data processing unit 20 detects the representative point cloud 94 of edges representing the detection object 80 based on the in-region point cloud 91a (step S307). The representative point cloud 94 is a point cloud representing positions of edges of the detection object 80. FIG. 13B shows the representative point cloud 94 of edges calculated based on the in-region point cloud 91a as the three-dimensional point cloud existing in the detection region 92. Further, FIG. 13C shows the distribution characteristic of the point cloud number with respect to the reflection intensity that is used when detecting the detection object 80.

The steps S108 and S109 as the operation of the registration processing unit 30 are the same as those in the first embodiment.

### <3-3> Effect

In the third embodiment, effects similar to those described in the first embodiment can be obtained.

Further, in the third embodiment, the calibration board having the calibration pattern is unnecessary, and thus the image data and the three-dimensional point cloud data can be made to be data in a common coordinate system by photographing and measuring the real space.

### <4> Industrial Applicability

By employing any one of the first to third embodiments, it is possible, for example, to make a display device display an image in which a three-dimensional point cloud generated by the LiDAR 52 is superimposed on a color image with high accuracy by photographing and measuring the real space in which a lot of objects exist. As a result, it becomes possible to display the depth of each part (distance to each part) of an object shown in a color image in a form understandable to a human (e.g., worker in the field of civil engineering) by using points in the three-dimensional point cloud.

Further, by employing any one of the first to third embodiments, it is possible, for example, to add colors based on a color image to a surface formed by a three-dimensional point cloud generated by the LiDAR 52 by photographing and measuring the real space in which a lot of objects exist. As a result, it becomes possible to display a surface formed by a three-dimensional point cloud in a form understandable to a human (e.g., worker in the field of civil engineering).

Furthermore, by employing any one of the first to third embodiments, it is possible, for example, to add colors based on a color image to points in a three-dimensional point cloud generated by the LiDAR 52 by photographing and measuring the real space in which a lot of objects exist. As a result, it becomes possible to display a three-dimensional point cloud in a form understandable to a human (e.g., worker in the field of civil engineering).

### DESCRIPTION OF REFERENCE CHARACTERS

1, 3: image point cloud data processing device, 10: image data processing unit, 20: point cloud data processing unit, 30: registration processing unit, 51: camera, 52: LiDAR (distance measurement sensor), 60: calibration board (reference object), 61: image feature point, 63, 83: image representative position, 64: edge (image representative position), 71, 91: three-dimensional point cloud, 71a, 91a: in-region point cloud, 72, 92: detection region, 73, 74, 94: representative point cloud, 80: detection object (reference object), 81: edge (image feature point), 101: processor, 102: memory, 103: storage device, 104: interface.

What is claimed is:

1. An image point cloud data processing device comprising:
processing circuitry
to detect a plurality of image feature points in a reference object included in image data generated by a camera and to calculate image representative positions as a plurality of three-dimensional positions representing the reference object based on the plurality of image feature points;
to detect an in-region point cloud, as a three-dimensional point cloud existing in a detection region determined based on the image representative positions, in three-dimensional point cloud data generated by a distance measurement sensor and indicating a three-dimensional point cloud, and to detect a representative point cloud representing the reference object based on the in-region point cloud; and
to make the image data and the three-dimensional point cloud data be data in a common coordinate system based on the image representative positions and the representative point cloud.

2. The image point cloud data processing device according to claim 1, wherein the reference object is a calibration board having a predetermined calibration pattern.

3. The image point cloud data processing device according to claim 2, wherein the image representative positions are coordinate points at corners of the calibration board.

4. The image point cloud data processing device according to claim 2, wherein the image representative positions are coordinate points on edges of the calibration board.

5. The image point cloud data processing device according to claim 1, wherein the reference object is a detection object detected in the image data.

6. The image point cloud data processing device according to claim 5, wherein the image representative positions are either or both of coordinate points at corners of the detection object and coordinate points on edges of the detection object.

7. The image point cloud data processing device according to claim 5, wherein the processing circuitry estimates the image representative positions of the reference object by using deep learning.

8. The image point cloud data processing device according to claim 1, further comprising:
the camera; and
the distance measurement sensor.

9. An image point cloud data processing method to be executed by an image point cloud data processing device, the method comprising:
detecting a plurality of image feature points in a reference object included in image data generated by a camera and calculating image representative positions as a plurality of three-dimensional positions representing the reference object based on the plurality of image feature points;
detecting an in-region point cloud, as a three-dimensional point cloud existing in a detection region determined based on the image representative positions, in three-dimensional point cloud data generated by a distance measurement sensor and indicating a three-dimensional point cloud, and detecting a representative point cloud representing the reference object based on the in-region point cloud; and
making the image data and the three-dimensional point cloud data be data in a common coordinate system based on the image representative positions and the representative point cloud.

10. A non-transitory computer-readable storage medium storing an image point cloud data processing program that causes a computer to execute:
detecting a plurality of image feature points in a reference object included in image data generated by a camera and calculating image representative positions as a plurality of three-dimensional positions representing the reference object based on the plurality of image feature points;
detecting an in-region point cloud, as a three-dimensional point cloud existing in a detection region determined based on the image representative positions, in three-dimensional point cloud data generated by a distance measurement sensor and indicating a three-dimensional point cloud, and detecting a representative point cloud representing the reference object based on the in-region point cloud; and
making the image data and the three-dimensional point cloud data be data in a common coordinate system based on the image representative positions and the representative point cloud.
